(19) United States
(12) Patent Application Publication
(10) Pub. No.: US 2025/0027469 A1
(43) Pub. Date: Jan. 23, 2025

(54) AIR INDUCTION SYSTEM FOR AN INTERNAL COMBUSTION ENGINE

(71) Applicant: FCA US LLC, Auburn Hills, MI (US)

(72) Inventors: Jennifer R Peters, Livonia, MI (US); Mark A Claeys, Oakland, MI (US)

(21) Appl. No.: 18/356,726

(22) Filed: Jul. 21, 2023

(51) Int. Cl. F02M 35/12; F02M 35/02

(52) U.S. Cl. CPC F02M 35/1261; F02M 35/0205; F02M 35/1288

(57) ABSTRACT

An air induction system for a vehicle internal combustion engine has an air filter box that couples with the internal combustion engine. A tuner, in the air filter box, removes offending lower frequency noise generated by the internal combustion engine. An air filter is positioned in the air filter box to filtering air entering the internal combustion engine.

### FIELD

The present disclosure relates to automotive vehicles with internal combustion engines and, more particularly, to an air induction system to mitigate unpleasant sound levels.

### BACKGROUND

This section provides background information related to the present disclosure which is not necessarily prior art.

In automotive vehicles, internal combustion engines can produce sound that is objectionable to the vehicle occupants resulting in customer dissatisfaction. Sound tuning devices are typically attached to air ducts between the air filter box and the engine to mitigate objectionable sound from the engine to the occupants. An adequate sound tuning device cannot be attached to the outside of the system, as would normally be done, due to a lack of packaging space in the engine compartment.

Previous solutions included a resonator or tuning device in the air ducts of the induction system. However, packaging limitations prevent the normal resonator assembly since there is limited space around the air ducts which means that a typical resonator system cannot be assembled in the engine compartment. Thus, it is desirable to provide noise tuning in the engine compartment. However, space limitations prevent the use of standard sound tuning devices, such as Helmholtz resonators, assembled on the air ducts between the engine and the air filter box.

The present disclosure provides a tuner, such as a Helmholtz resonator, that is fully enclosed within an air filter box. The present disclosure removes the offending lower frequency noises generated by internal combustion engine. The present disclosure enables tuning to any desired frequency to address the engine noise. Further, the present disclosure enables access to the tuning device from the outside to readily provide additional volume for the tuning device, if desired.

### SUMMARY

This section provides a general summary of the disclosure, and is not a comprehensive disclosure of its full scope or all of its features.

According to a first aspect of the disclosure, an air induction system for a vehicle engine comprises an air filter box for coupling with an internal combustion engine. A tuner is positioned in the air filter box to remove offending lower frequency noise generated by the internal combustion engine. An air filter is positioned in the air filter box to filter the air entering the internal combustion engine. The tuner is positioned below the air filter. The tuner is a Helmholtz resonator tuned to remove a specific sound frequency. The resonator is accessible from outside the air filter box and can be substituted for another resonator if additional volume is required. Also, the resonator can be tuned to a desired frequency to eliminate engine noise.

According to a second aspect of the disclosure, a vehicle internal combustion engine includes an air induction system comprising an internal combustion engine and an air filter box for coupling with an internal combustion engine. A tuner is positioned in the air filter box to remove offending lower frequency noise generated by the internal combustion engine. An air filter is positioned in the air filter box to filter the air entering the internal combustion engine. The tuner is positioned below the air filter. The tuner is a Helmholtz resonator tuned to remove a specific sound frequency. The resonator is accessible from outside the air filter box and can be substituted for another resonator if additional volume is required. Also, the resonator can be tuned to a desired frequency to eliminate engine noise.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view of an internal combustion engine with air induction system.

FIG. 2 is a plan view of the air filter box with a cover and air filter removed.

FIG. 3 is a cross-section view of the air filter box of FIG. 2.

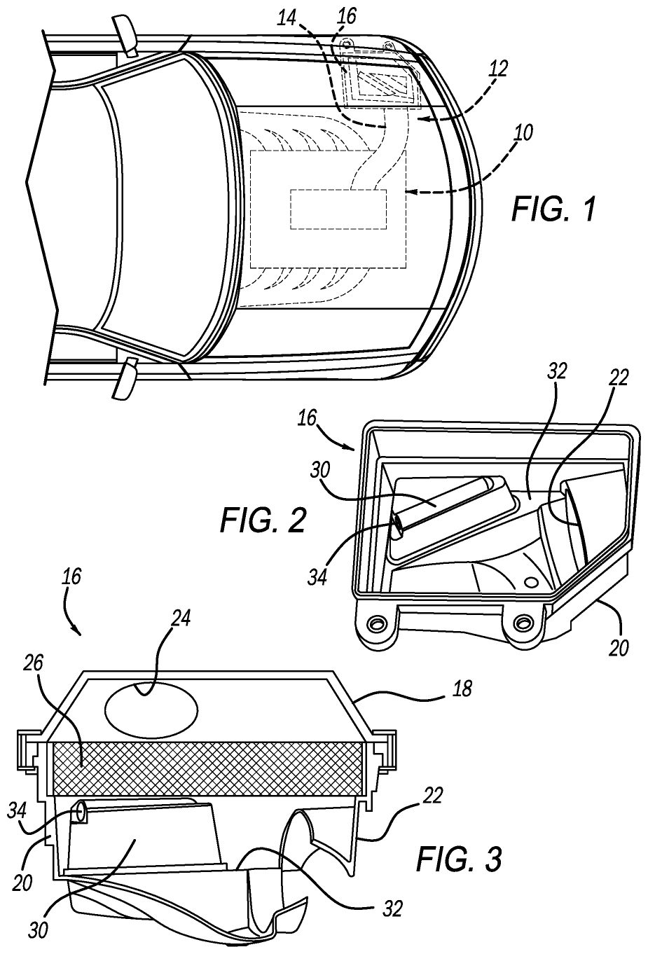

Corresponding reference numerals indicate corresponding parts throughout the several views of the drawings.

### DETAILED DESCRIPTION

Example embodiments will now be described more fully with reference to the accompanying drawings.

Turning to the figures, an internal combustion engine is illustrated and designated with the reference numeral 10. An air induction system 12 is coupled with the internal combustion engine 10. The air induction system 12 includes an air duct 14 coupled with an air filter box 16. The air induction system 12 provides egress of ambient air into the internal combustion engine 10.

The air filter box 16 includes a cover 18 and a base 20. The base 20 includes an outlet 22 coupling with the air duct 14 and an air inlet 24 to enable egress of ambient air into the air filter box 16. An air filter 26 is positioned on a ledge in the base 24. A tuner 30 is positioned on a ledge 32 in the base 20. The ledge 32 extends a desired distance from a wall of the base 20. Generally, the resonator 30 sits entirely on the ledge 32. The tuning device 30 is a Hemholtz resonator. The tuning device 30 includes an opening 34 to receive air entering into the Hemholtz resonator 30. The Hemholtz resonator 30 receives ambient air that is flowing into the engine. The resonator 30 is used to mitigate unpleasant sound levels of the engine noise passing from the engine 10 through the induction system 12 and to the driver and passengers' ears. Low frequency sound is unpleasant and distracting to the driver and passengers. Constraints on available space in the engine compartment prevent the placement of a sound tuning device, such as a resonator, in the engine compartment that will impact and remove the unpleasant frequencies. With the resonator inside the air filter box 16, the vehicle occupants do not hear the low level frequencies.

Accordingly, the Hemholtz resonator 30 is fully enclosed within the air filter box 16. The Hemholtz resonator 30 removes offending lower frequency noise generated by the internal combustion engine 10. The resonator 30 can be tuned to any desired frequency to address the engine noise. If additional volume is required internal to the air filter box 16, the tuning device 30 can be accessed from outside and substituted with an additional or second Hemholtz resonator having a different volume. This adjusts for the desired frequency of the noise generated by the internal combustion engine.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An air induction system for a vehicle engine comprising:
an air filter box for coupling with an internal combustion engine;
a tuner in the air filter box for removing offending lower frequency noise generated by the internal combustion engine; and
an air filter positioned in the air filter box for filtering air entering the internal combustion engine.

2. The air induction system of claim 1, wherein the tuner is positioned below the air filter.

3. The air induction system of claim 1, wherein the tuner is a Helmholtz resonator tuned to remove a specific sound frequency.

4. The air induction system of claim 3, wherein the resonator is accessible from the air filter box.

5. The air induction system of claim 3, wherein the resonator can be substituted for a second resonator if additional volume is required.

6. The air induction system of claim 3, wherein tuning the resonator to a desired frequency for eliminating engine noise.

7. The air induction system of claim 1, wherein the air filter box includes a ledge for receiving the tuner.

8. A vehicle internal combustion engine including air induction system comprising:
an internal combustion engine;
an air filter box for coupling with an internal combustion engine;
a tuner in the air filter box for removing offending lower frequency noise generated by the internal combustion engine; and
an air filter positioned in the air filter box for filtering air entering the internal combustion engine.

9. The vehicle internal combustion engine of claim 8, wherein the tuner is positioned below the air filter.

10. The vehicle internal combustion engine of claim 8, wherein the tuner is a Helmholtz resonator tuned to remove a specific sound frequency.

11. The vehicle internal combustion engine of claim 10, wherein the resonator is accessible from the air filter box.

12. The vehicle internal combustion engine of claim 10, wherein the resonator can be substituted for a second resonator if additional volume is required.

13. The vehicle internal combustion engine of claim 10, wherein tuning the resonator to a desired frequency for eliminating engine noise.

14. The vehicle internal combustion engine of claim 8, wherein the air filter box includes a ledge for receiving the tuner.
